(19) United States
(12) Patent Application Publication
(10) Pub. No.: US 2008/0314358 A1
(43) Pub. Date: Dec. 25, 2008

(54) System For Spraying Water Into The Combustion Air Drawn Into The Intake Of Vehicle And Industrial Internal Combustion Engines

(76) Inventor: Jorge Omar Fioramonti, Buenos Aires (AR)

Correspondence Address: DEFILLO & ASSOCIATES, INC., P.O. Box 14104, Clearwater, FL, 33766, US

(21) Appl. No.: 12/096,541

(22) PCT Filed: Dec. 15, 2006
(86) PCT No.: PCT/EC06/00008

§ 371 Date: Jun. 6, 2008

(30) Foreign Application Priority Data
Dec. 15, 2005 (AR) P 050105282

(51) Int. Cl. F02B 47/02

(52) U.S. Cl. 123/25 A

(57) ABSTRACT

The invention relates to a system for spraying water into the combustion air drawn into the intake of vehicle and industrial internal combustion engines. The inventive system consists of a preferably-distilled water supply circuit including at least one water container which is provided with a supply mouth and a control cover which is mounted on a frame support. According to the invention, functionally-interconnected elements, which are automatically and externally controlled by an electronic board, are provided on the base of the above-mentioned container, submerged in the fluid therein. The aforementioned elements consist of a filter which is associated with an electromagnetic metering pump by means of connectors and a water delivery conduit section, said pump drawing in and driving a flow of water. One side of the pump is connected to a water flow control valve and the respective manually-controlled calibrated return element thereof by means of connectors and conduit sections. Connectors and conduit sections are used to connect said control valve to a safety valve for interrupting the flow of water and the water path then extends through a conduit section to an outlet connector through which water is released from the container. Outside of the container, the water then passes through a conduit section housing a one-way valve until it reaches a support flange of a sprayer with a drain valve, which is disposed inside the tube used to draw in the stream of combustion air.

### CROSS REFERENCE TO RELATED APPLICATION

This application is a national stage entry of PCT/EC2006/000008 filed Dec. 15, 2006, under the International Convention claiming priority over Argentina application No. P20050105282 filed Dec. 15, 2005.

### FIELD OF THE INVENTION

The invention relates to a system for spraying water into the combustion air drawn into the intake of vehicle and industrial internal combustion engines, and it is related specifically to the mechanical field and specifically with the branch of automotive transport, moped, boats, equipment and machines such as agricultural, construction, rolling, and stationary.

The system manages to spray, in controlled form according to the different motor settings, a certain amount of water into the combustion air drawn and later along with the ideal fuel proportions sensitively improve its combustion conditions, with the objective of increasing the engine power, significantly reducing the particle emanation of polluting agents and obtaining fuel economy, among others.

These important objectives are obtained by means of the use of components of simple structuring and easy operation that in the practice has proven to have a high degree of reliability. These include an impulsion fluid pump, flow regulation valve, water filter, an unloading nozzle, a safety valve of cutting, bridle associated with a water sprayer and a water tank. The combination of these simple elements defines an economic system of easy installation, high reliance and versatility, since with slight modifications and without separating from the proposed inventive objective, it is possible to install in all types of vehicular and industrial motors, with fuel supply such as: gasoline, diesel oil, compressed natural gas (GNC), liquefied gas (GLP), hydrogen (H₂), biodiesel, and others.

### BACKGROUND OF THE INVENTION

For many years the automotive industry, in general, has been worried about improving the main aspects of the vehicles that they make; which can be subdivided into three aspects for the analysis of the present invention, since many other aspects exist that escape from this analysis. They are:

a) improving the engine power in general,
b) obtaining a smaller fuel consumption per kilometer run, and
c) trying to eliminate the polluting particles that emanate from the motor exhaust pipe.

It is a widely-known technical fact that the addition of water to the air admission of the internal combustion motors produces a phenomenon that increases the effective power, reduces the hour consumption and mitigates the emissions of CO and HC and the particles that form from the incomplete combustion of the fuel mixture.

It is also known that introducing water and other noncombustible substances in the combustion chamber increases the efficiency of the internal combustion engine. The water can be introduced by three forms which are believed to be advantageous to know:

1) Direct water injection in the combustion chamber (for example German patent DE A-3 432 787 or U.S. Pat. No. 4,408,573).
2) Introduction of water steam or very humid air in the current of the admission tube of the combustion chamber (for example the German patent DE-A-2 602 287 or U.S. Pat. No. 4,479,907).
3) Preparation and introduction of fuel and water emulsion in the combustion chamber (for example the German patent DE-A-3 236 233 or U.S. Pat. No. 4,191,512 and the publication of Japanese patent application JP 2003035212).

These well-known systems work in agreement with one or more operative parameters, such as the number of motor revolutions (for example U.S. Pat. No. 4,191,134), the depression in the admission tube (for example U.S. Pat. No. 4,240,380), the rattling or pricked of the motor (for example U.S. Pat. No. 4,406,255), the pressure of the exhaust gases (for example U.S. Pat. No. 4,191,134), and/or the temperature in the admission tube (for example European patent EP-A-0009779).

In addition, the prior art has been concentrated in the design of water addition devices, in micronized and regulated form, to the air admission or the combustion chamber, like in the following mentioned patents.

The Argentinean Patent AR 253.677 of Sep. 27, 1999, of the same applicant, which relates to the addition of water to the admission air by means of a system that feeds by gravity, from a water tank placed at higher elevated level, to a circuit that includes water filters, pneumatic or magnetic safety valves that cut the water flow when the motor is not working, and a water measured needle valve calibrated according to the piston displacement of the motor. Included in the circuit there is a tower that acts as a water reservoir and avoids the circuit to drains in view of a sudden water demand. A double jet cushions the momentarily excessive water suction by the cylinders. Finally a water jet nozzle with inverted conical perforations in its end serves as air flow accelerator that, when passing through the nozzle, acts as a water nebulizer.

Numerous evaluations of the invention prototypes indicate that the optimal dose should be limited between 1% and 5% of water in relation to the fuel used for each piston displacement of the motor.

The publication of the US Application U.S. 2003140873 to Wook of Jul. 31, 2003, relates to a water injection device in a motor combustion chamber to diminish smoke and is characterized by a water injector associated to a water supply mechanism to be placed inside a motor suction tube.

The problem is how to, in a controller manner, dose the water in the correct measurement according to the motor requirements and according to its changing operating method.

Different control methods have been described in several patent publications:

In U.S. Pat. No. 4,351,289 to Renda of Sep. 28, 1982, the water injection is performed by a pump under the control of a switch that controls the vacuum in the admission manifold and step in at a determined level of the motor torque.

In U.S. Pat. No. 3,866,579 to Serruys of the Feb. 18, 1975, an amount of water is sprayed that responds to a mechanism that controls the motor load. As it is known, the load depends on the suction (or degree of vacuum) that is obtained in the admission conduit, passed through the butterfly valve, the control is performed by means of a pressurized capsule and also by controlling the volume of gas through a nozzle or orifice of constant section.

U.S. Pat. No. 4,563,982 to Pischinger of the Jun. 14, 1986, describes a method of flow control of the water volume injected in relation to the gas that is injected directly by pressure in the camera of the motor. The amount of water is regulated according to the position of the butterfly valve, or phase calipers that determine the degree of motor rattling.

In U.S. Pat. No. 4,096,829 of Apr. 19, 1976, the water injection is controlled by means of electrical pulses transmitted from the distributor that stay in direct proportion to the RPM of the motor. The control system only starts at 2000 RPM and according to the vacuum detected in the admission manifold.

An electronic system responds to the pulse frequency connected to an analogical converter.

In U.S. Pat. No. 4,240,830 to Slagle is described a water injection method in which the water is pumped through a nozzle whose volume is controlled by a diaphragm that responds in direct relation to the pressure ene Manifold of admission.

In general, the systems, devices, apparatuses and methods previously mentioned to control the amount of water by time unit that are incorporated to the motor admission allows the water injection to respond to the air volume admission according to the cylinder suction, that varies as well according to RPM and the consequent relation combustible/air of each method of operation and, in addition, the piston displacement to the motor.

### SUMMARY OF THE INVENTION

Departing from the present state and the previous art of the mentioned field technique, the concrete objective of the invention is based on a system, installed in the vehicular and industrial internal combustion motor, based on the principle of automatically controlling water spray for each motor revolution and the power required to the admission of the air combustion that along with the fuel, managed to lower the combustion temperature, increase the pressure and reduce the particulate emission.

This improvement consists of a special arrangement of elements that belong to this system, which are in submerged conditions inside a fluid deposit, preferably distilled water, such that they generate melting heat during winter times thus the water is not frozen and during the summer time these submerged elements stay cooled; eliminating the effect of temperature increase thereof. With this is obtained a sealed unit with a greater control of the sprayed water particles in the air admission combustion hose and following the route to the combustion chamber of the motors of internal combustion, increasing the engine efficiency and the effectiveness of the system mitigating the emissions of CO, HC, smoke and to avoid the formation of Nox.

The system mainly comprises:
a water feeding deposit;
an aspiring and propulsive measured electromagnetic pump of water volume;
a regulating valve of water volume;
a water flow safety valve of cutting bridle associated to a sprayer with its water drainage valve;
electronic chip with control and operation means; and
technical operative components for the operation altogether of the enunciated preceding elements.

### BRIEF DESCRIPTION OF THE DRAWINGS

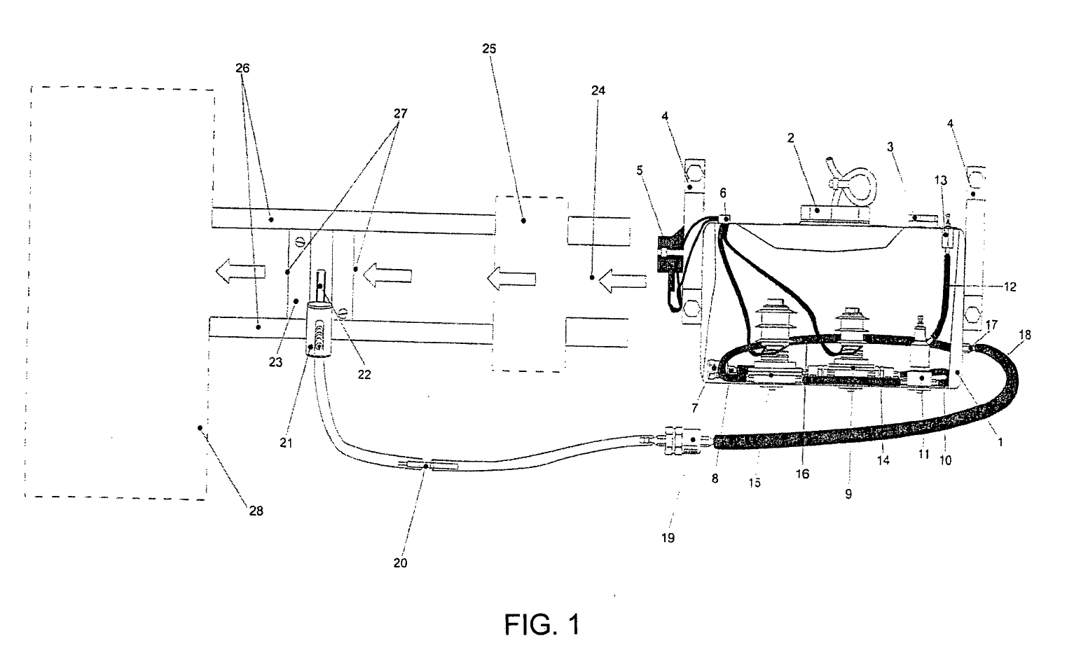

In FIG. 1, a schematic representation of the different components, operatively connected to each other of this installed system and disposed on board of the vehicular and industrial motors of internal combustion.

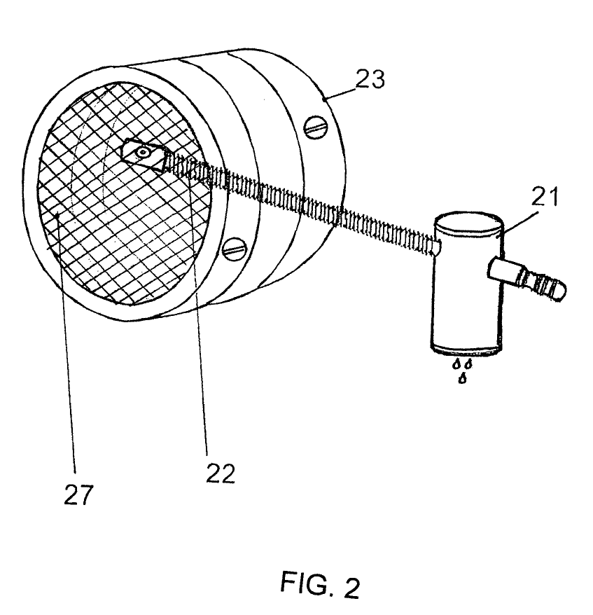

In FIG. 2, a schematic representation of a denominated component called bridle associated to a sprayer with its drainage valve.

### LISTING OF THE COMPONENTS OF THE SYSTEM

1. water storage deposit
2. deposit supplying nozzle
3. regulation stopper
4. support chassis
5. chip with electronic control and operation means
6. terminal board of connection
7. internal water filter
8. connectors and water pipe conduction sections to the pump, arranged inside the deposit and in submerged conditions
9. water flow propelling and aspiring measured electromagnetic pump, arranged in the interior of the deposit and in submerged conditions
10. connectors and conducting pipe sections of water pump—regulating valve, arranged inside the deposit and in submerged conditions
11. water volume regulating valve, disposed inside the deposit and in submerged conditions
12. pipe section of return for the regulating valve
13. return with calibrated step of manual regulation
14. connectors and pipe sections of water conduction, regulating valve, safety valve of cutting, disposed inside the deposit and in submerged conditions
15. safety valve of water flow cutting, disposed inside the deposit and in submerged conditions
16. exit conduction pipe section of the safety valve of cutting, disposed inside the deposit and in submerged conditions
17. external connector to the water exit deposit
18. pipe section of external water conduction to the deposit
19. water flow external filter
20. unidirectional water flow valve
21. drainage valve
22. water flow sprayer
23. bridle
24. entrance collector of combustion air
25. air filter
26. admission hose of combustion air
27. woven mesh arranged in both ends of the bridle
28. motor

### DETAILED DESCRIPTION OF THE INVENTION

FIG. 1, represents the system to spray water according to a proportion from 1 to 5% of the fuel in the existing mixture and installed on board thereof, that includes a preferably-distilled water supply circuit including at least one water container deposit (1) with its supplying nozzle (2) and regulation stopper (3) mounted on a chassis support (4), characterized because in the interior and the base of this deposit (1) the elements placed in submerged conditions inside this fluid are placed operatively and linked to each other and externally commanded in automatic form by means of an electronic chip (5), constituted these elements by a filter (7) associated by means of connectors and water conduction sections (8) to a water flow propelling and aspiring measured electromagnetic pump (9), which on one side communicates through connectors and conduction pipe sections (10) with a water flow regulating valve (11) with its respective return of way with calibrated step of manual regulation (13), and over this at the same time communicates through connectors and pipe of water conduction (14) to a water flow safety valve of cutting (15), continuing the trajectory by a conduction pipe section (16) to water exit connector (17) of this deposit (1), passing later in external conditions to this deposit (1) by a pipe conduction section that accommodates in its interior a unidirectional valve (20) of this fluid finalizing in a lifting bridle (23) of a sprayer (22) with its drainage valve ready in the interior of the admission hose of the combustion air (26).

FIG. 2, represents the lifting bridle (23) of a sprayer (22) including a hollow cylindrical body, of adaptable outer diameter to the suction hose (26), in which ends have a woven mesh (27) to obtain a vortex effect of the air mass—water suctioned in the different motor settings (28).

### Basic Principle of Operation

The water, preferably distilled, which contains the deposit, goes first through a filter element to continue its way and enter to a water flow measured pump electronically commanded by pulses of a chip with electronic command and control means, following its trajectory to a valve which regulates the water flow with respect to the suction of the motor admission, which has an adjustable return to alleviate the pressure of the pump, later this flow passes through a cutting valve that is driven by the contact of the motor, again the flow is filtered in the exterior of the deposit, continuing by a conduction pipe section in which in its trajectory point passes through an unidirectional valve (of non-return water flow), and finally arrives at a drainage valve and sprayer, which is incorporated into a bridle that is installed in the air combustion admission hose of the motors, which is in the air filter and the admission manifold.

In addition, by means of tests made by the own inventor were obtained important parameters that deserve to be mentioned, according to the application in motors fed by compressed natural gas (GNC), it was preferably used water spray in the motor according to a proportion from 0.2 to 1% of the fuel present in the mixture, obtaining a greater performance-thereof.

In agreement with all previously exposed and illustrated, it is easy to understand the advantages of practical order that offers this system; therefore the annexed claims cover the reach with the invention.

1-2. (canceled)

3. A system for spraying water into a combustion air drawn into an intake of vehicle or industrial internal combustion engines, wherein the water is spray according to a proportion from 1% to 5% of fuel present in a mixture, the system comprising:
a water feeding circuit including at least one water container deposit with a supplying nozzle and a regulation stopper mounted on a chassis support, wherein the water deposit includes a base, an interior, and an exterior;
wherein in the interior and the base of the deposit elements are placed in submerged conditions inside the water, operatively linked to each other and externally commanded in automatic form by means of an electronic chip;
wherein the elements include a filter associated by means of connectors and water conduction sections to a water flow propelling and aspiring measured electromagnetic pump, wherein the electromagnetic pump includes a first side and a second side;
wherein the first side of the pump communicates through connectors and conduction pipe sections with a water flow regulating valve with its respective return of way with calibrated step of manual regulation, and
wherein the second side of the pump communicates through connectors and pipes of water conduction to a water flow safety valve of cutting, continuing the trajectory by a conduction pipe section to a water exit connector on the deposit, passing later in external conditions to the deposit by a pipe conduction section that accommodates in its interior a unidirectional valve of the water finalizing in a lifting bridle of a sprayer with its drainage valve ready in the interior of the admission hose of the combustion air.

4. The system according to claim 3 wherein the lifting bridle of the sprayer comprises a hollow cylindrical body, having an outer diameter adaptable to the suction hose, in which ends have a woven mesh to obtain a vortex effect of the air mass-water suctioned in the different motor settings.

5. The system according to claim 3 wherein the a-water is distilled water.
